(19) United States
(12) Patent Application Publication
(10) Pub. No.: US 2005/0043968 A1
(43) Pub. Date: Feb. 24, 2005

(54) Message data processing system suitable for healthcare and other fields

(76) Inventor: Kevin Sauerwald, Harleysville, PA (US)

Correspondence Address: Alexander J. Burke;170 Wood Avenue South, Intellectual Property Department 5th Floor, Iselin, NJ, 08830, US

(21) Appl. No.: 10/912,931

(22) Filed: Aug. 6, 2004

Related U.S. Application Data
(60) Provisional application No. 60/494,347, filed on Aug. 11, 2003.
(60) Provisional application No. 60/500,140, filed on Sep. 4, 2003.

(51) Int. Cl. G06F 17/60

(52) U.S. Cl. 705/2

(57) ABSTRACT

A message data processing system suitable for processing messages identifying transactions includes an input processor, a parser, one or more repositories, and a data processor. The input processor receives data representing a message. The parser parses received message data to identify an individual data field in the message data. The one or more repositories contain ancillary information associated with data fields of the message data. The data processor retrieves ancillary information, associated with the identified data field of the message data, from the one or more repositories, and processes the retrieved associated ancillary information together with information in the data field for output.

### CROSS-REFERENCE TO RELATED APPLICATIONS

The present application claims priority to Provisional Application Ser. No. 60/494,347, filed Aug. 11, 2003; and Provisional Application Ser. No. 60/500,140, filed Sep. 4, 2003.

### FIELD OF THE INVENTION

The present invention generally relates to computer information systems. More particularly, the present invention relates to a message data processing system and method therefor suitable for healthcare and other fields.

### BACKGROUND OF THE INVENTION

Some healthcare software applications are specifically tailored to a particular healthcare department (e.g., a Radiology Management System (“RMS”)), and provide healthcare information that is specific and relevant to the particular healthcare department.

Other healthcare software applications provide healthcare information compatible with a Health Level 7 (“HL7”) communication standard, but these applications do not provide healthcare information that is specific and relevant to a particular healthcare department. A user typically determines HL7 compatible healthcare information that is specific and relevant to a particular healthcare department by manually counting delimiters, separating fields of information in an HL7 message, and by manually looking up a field that is represented between a set of delimiters to interpret the information in the field. This manual process is time consuming and often leads to errors.

Accordingly, there is a need for a message data processing system and method therefor suitable for healthcare and other fields that provides healthcare information compatible with a HL7 communication standard, for example, and provides healthcare information that is specific and relevant to a particular healthcare department in a format that is user friendly.

### SUMMARY OF THE INVENTION

A message data processing system suitable for processing messages identifying transactions includes an input processor, a parser, one or more repositories, and a data processor. The input processor receives data representing a message. The parser parses received message data to identify an individual data field in the message data. The one or more repositories contain ancillary information associated with data fields of the message data. The data processor retrieves ancillary information, associated with the identified data field of the message data, from the one or more repositories, and processes the retrieved associated ancillary information together with information in the data field for output.

### BRIEF DESCRIPTION OF THE DRAWINGS

FIG. 1 illustrates a message data processing system, in accordance with a preferred embodiment of the present invention.

FIG. 2 illustrates a method for processing message data identifying transactions for the system, as shown in FIG. 1, in accordance with a preferred embodiment of the present invention.

FIG. 3 illustrates a user interface window for the input process of the system and method, as shown in FIGS. 1 and 2, respectively, in accordance with a preferred embodiment of the present invention.

FIG. 4 illustrates a user interface window for the parsing process of the system and method, as shown in FIGS. 1 and 2, respectively, in accordance with a preferred embodiment of the present invention.

FIG. 5 illustrates a user interface window for the transaction breakdown of the system and method, as shown in FIGS. 1 and 2, respectively, in accordance with a preferred embodiment of the present invention.

FIG. 6 illustrates a user interface window for the data field lookup of the system and method, as shown in FIGS. 1 and 2, respectively, in accordance with a preferred embodiment of the present invention.

FIG. 7 illustrates a user interface window for the transaction statistics of the system and method, as shown in FIGS. 1 and 2, respectively, in accordance with a preferred embodiment of the present invention.

FIG. 8 illustrates a user interface window for the transaction results of the system and method, as shown in FIGS. 1 and 2, respectively, in accordance with a preferred embodiment of the present invention.

### DETAILED DESCRIPTION OF THE PREFERRED EMBODIMENTS

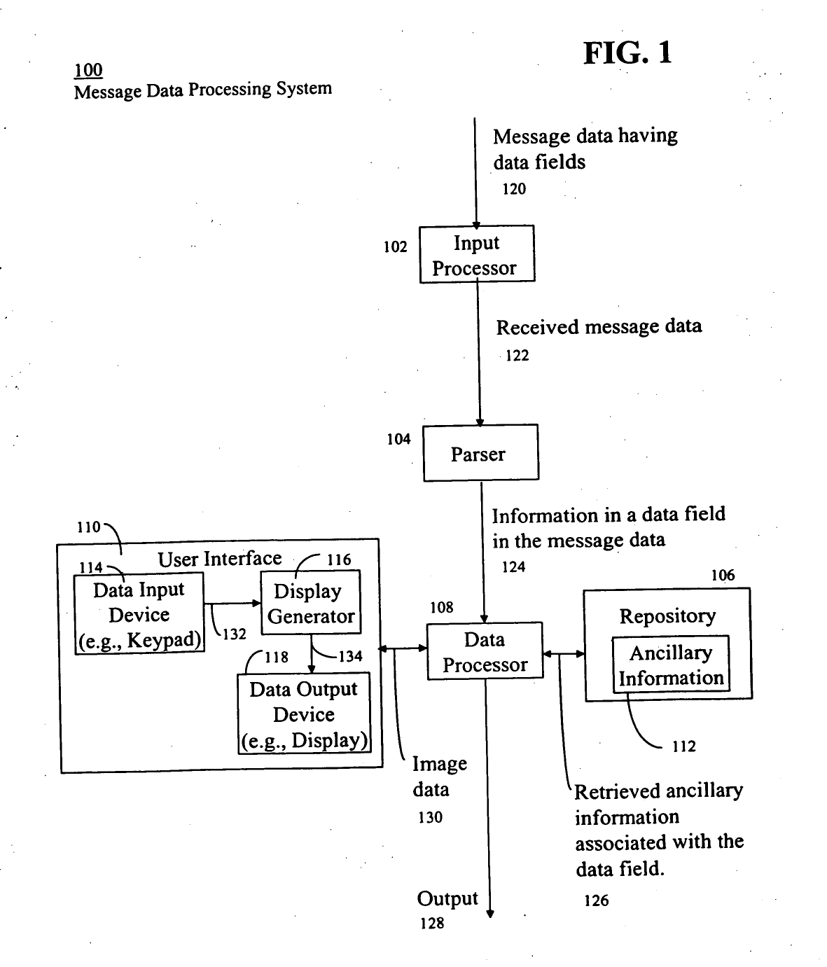

FIG. 1 illustrates a message data processing system (“system”) 100. The system. 100 includes an input processor 102, a parser 104, a repository 106, a data processor 108, and a user interface 110. The repository 106 further includes ancillary information 112, as described herein. The user interface 110 further includes a data input device 114, a display generator 116, and a data output device 118.

The system 100 is intended for use by a healthcare provider that is responsible for servicing the health and/or welfare of people in its care. A healthcare provider may provide services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, a user, and an individual.

The system 100 is suitable for processing messages 120 identifying transactions. The input processor 102 receives data representing a message 120 to produce received message data 122. The parser 104 parses the received message data 122 to identify information in an individual data field 124 in the received message data. The repository 106 contains ancillary information 112 associated with data fields of the received message data 122. The data processor 108 retrieves the ancillary information 112, associated with the identified data field of the received message data 122, from the repository 106, and processes the retrieved associated ancillary information 126 together with information in the data field 124 for output 128.

The input processor 102 represents any type of communication interface that receives any type of signal, such as message data 120 including data fields. The message data 120 concerns a healthcare activity relating to a patient. The healthcare activity comprises one or more of the following: (a) patient admission, discharge or transfer from a hospital, (b) patient allergies, (c) radiology, (d) laboratory tests, (e) medication, (f) diet, and (g) therapy.

The parser 104 represents any type of processing element that parses signals. Parsing may otherwise be called dissecting, separating, distinguishing, identifying, categorizing, sorting, etc.

The repository 106 represents a data storage element and may otherwise be called a memory device, a storage device, a database, etc. The database may be of any type including for example, a Microsoft® (MS) Access® database. The repository 106 contains ancillary information 112 associated with the identified data field of the message data 12. The ancillary information 112 may otherwise be called additional, extra, supplemental information, etc. The ancillary information 112 associated with the identified data field of the message data 124 includes information derived from a clinical information database associated with the healthcare activity, such as that specific and relevant to a particular healthcare department. The ancillary information 112 includes one or more of the following: (a) activity type, (b) activity sub-type, (c) medical record number associated with the patient, (d) admission number associated with the patient, (e) a corporation identifier, (f) a visit identifier, (g) a patient identifier, and (h) a physician associated the healthcare activity.

The data processor 108 processes the retrieved associated ancillary information 126 together with information in the data field 124 for output 128 to one or more of the following: (a) a display on a reproduction device, (b) communication to a remote system, and (c) print output. The output 128 may be the same or different than the image data 130 communicated to the user interface 110.

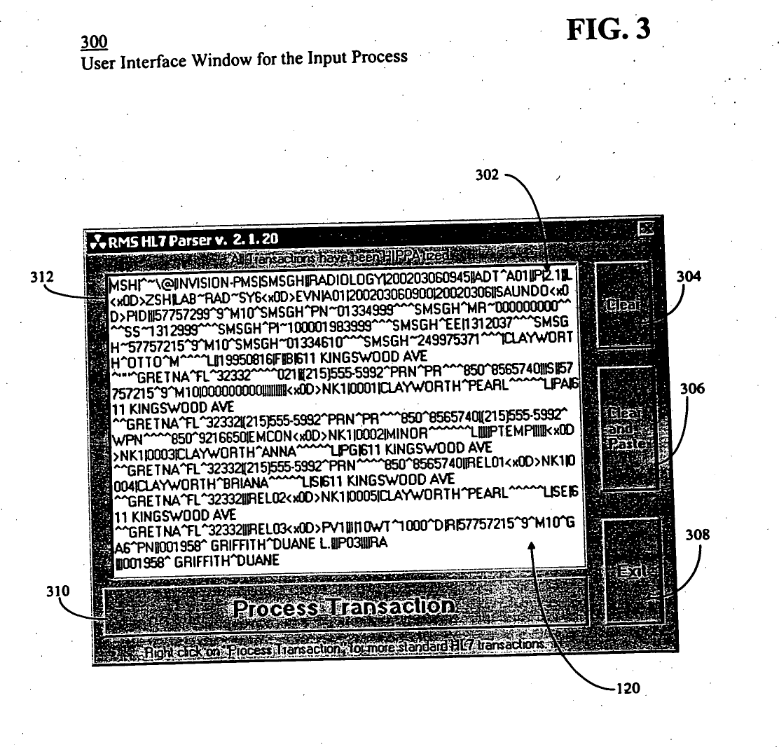

The user interface 110 permits a user to interact with the system 100 by inputting data into the system 100 and/or receiving data from the system 100. The user interface 110 generates one or more display images, as shown in FIGS. 3-8, for example.

The data input device 114 provides data 132 to the display generator 116 in response to receiving input information either manually from a user or automatically from an electronic device. The data input device 114 is a keyboard, but also may be a touch screen, or a microphone with a voice recognition program, for example.

The display generator 116 generates display signals 134, representing one or more images for display, in response to receiving the data 132 or other data from the system 100, such as the image data 130 from the data processor 108. The display generator 116 is a known element including electronic circuitry or software or a combination of both for generating display images or portions thereof. The image for display may include the retrieved ancillary information 126 and may include information associated with the identified data field 124. An action by a user, such as, for example, an activation of a displayed button, may cause the image to be displayed.

The data output device 118 represents any type of element that generates data. The data output device 118 is a display that generates display images in response to receiving the display signals 134, but also may be a speaker or a printer, for example.

The user interface 110 provides a graphical user interface (GUI), as shown in FIGS. 3-8, wherein at least portions of the data input device 114 and at least portions of the data output device 118 are integrated together to provide a user-friendly interface. In an alternative embodiment, the GUI, as shown in FIGS. 3-8, may be formed as a web browser. A web browser forms a part of each of the data input device 114 and the data output device 118 by permitting information to be entered into the web browser and by permitting information to be displayed by the web browser.

In the system 100, one or more elements may be implemented in hardware, software, or a combination of both. Further, one or more elements may include one or more processors, such as the input processor 102, the parser 104, the data processor 108, and the display generator. A processor includes any combination of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or microprocessor.

A processor performs tasks in response to processing an object. An object comprises a grouping of data and/or executable instructions, an executable procedure, or an executable application. An executable application comprises code or machine readable instruction for implementing predetermined functions including those of an operating system, healthcare information system, or other information processing system, for example, in response user command or input. The system 100 is written in Microsoft® Visual Basic 6.0, for example.

The system 100 may be fixed or mobile (i.e., portable), and may be implemented in a variety of forms including a personal computer (PC), a desktop computer, a laptop computer, a workstation, a network-based device, a personal digital assistant (PDA), a smart card, a cellular telephone, a pager, and a wristwatch. The system 100 may be implemented in a centralized or decentralized configuration.

The system 100 provides an electronic mechanism for a healthcare provider (otherwise called a “worker” or “user”) to analyze healthcare information in the form of message data associated with a transaction or record. The healthcare information may be represented in a variety of file formats including numeric files, text files, graphic files, video files, audio files, and visual files. The graphic files include a graphical trace including, for example, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The system 100 communicates with remote computer systems over a wired or wireless communication path, otherwise called a network, a link, a channel, or a connection. The communication path may use any type of protocol or data format including an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, a Digital and Imaging Communications (DICOM) protocol, and a Health Level Seven (HL7) protocol.

The system processes message data 120 for healthcare transactions using the Health Level Seven (HL7) compatible protocol. A transaction comprises an activity associated with delivering healthcare to a patient. The image for display indicates that the identified data field is a particular HL7 data field. Health Level Seven, having a website at http://www.h17.org, is one of several American National Standards Institute (ANSI) accredited Standards Developing Organizations (SDOs) operating in the healthcare field. Most SDOs produce standards (sometimes called specifications or protocols) for a particular healthcare domain such as pharmacy, medical devices, imaging, or insurance (e.g., claims processing) transactions. HL7 is concerned with is clinical and administrative data. HL7 provides standards for the exchange, management, and integration of data that support clinical patient care and the management, delivery and evaluation of healthcare services. HL7 creates flexible, cost effective approaches, standards, guidelines, methodologies, and related services for interoperability between healthcare information systems.

“Level Seven” in HL7 refers to the highest level of the International Standards Organization's (ISO) communications model for Open Systems Interconnection (OSI), known as the application level. The application level addresses definition of the data to be exchanged, the timing of the interchange, and the communication of certain errors to the application. The application level supports such functions as security checks, participant identification, availability checks, exchange mechanism negotiations, and data exchange structuring.

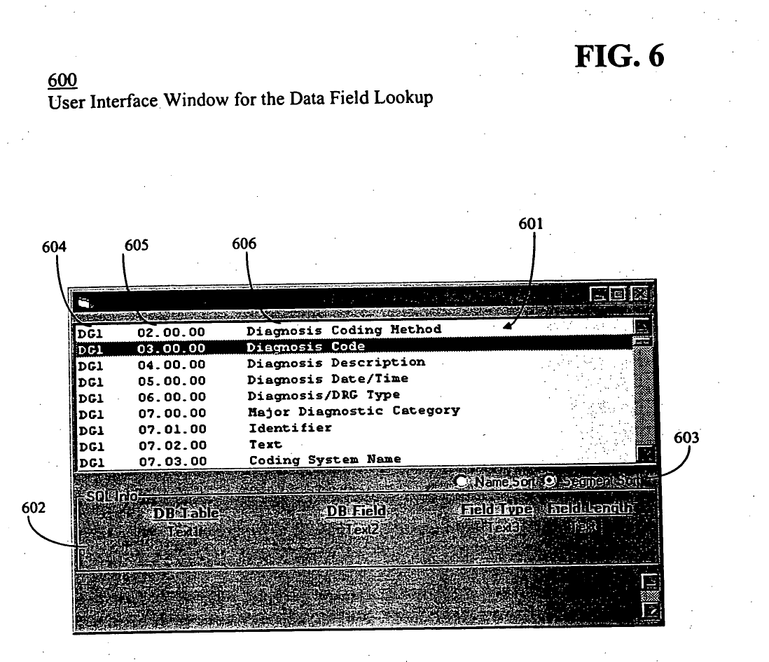

According to one aspect of the present invention, the system 100 makes it easier for a user to view HL7 transactions that are received by healthcare information systems by automatically parsing the message data 120 in a transaction, and automatically provides a description of the field that the user has selected. The system 100 performs the automatic parsing process by automatically identifying identifiers that separate fields of information in the HL7 message, which is described in further detail with reference to FIGS. 3, 4, and 5. The system 100 performs the process of automatically providing a description of the field by automatically looking up a field that is represented by the identifiers to interpret the information in the field, which is described in further detail with reference to FIG. 6.

For example, HL7 information has standard field labels that identify a hierarchy of field labels from a segment (i.e., high) level to a sub-component (i.e., low) level. An example of a standard HL7 field label is patient identification (“ID”) five (i.e., “PID 5”), which represents “patient name.” Field label PID 5 is further broken down into field labels PID 5.1 and PID 5.2, which represent “family name” and “given name,” respectively. The parsing process automatically parses the hierarchy of field labels in the message data 120, and automatically provides a description of the field label that the user has selected.

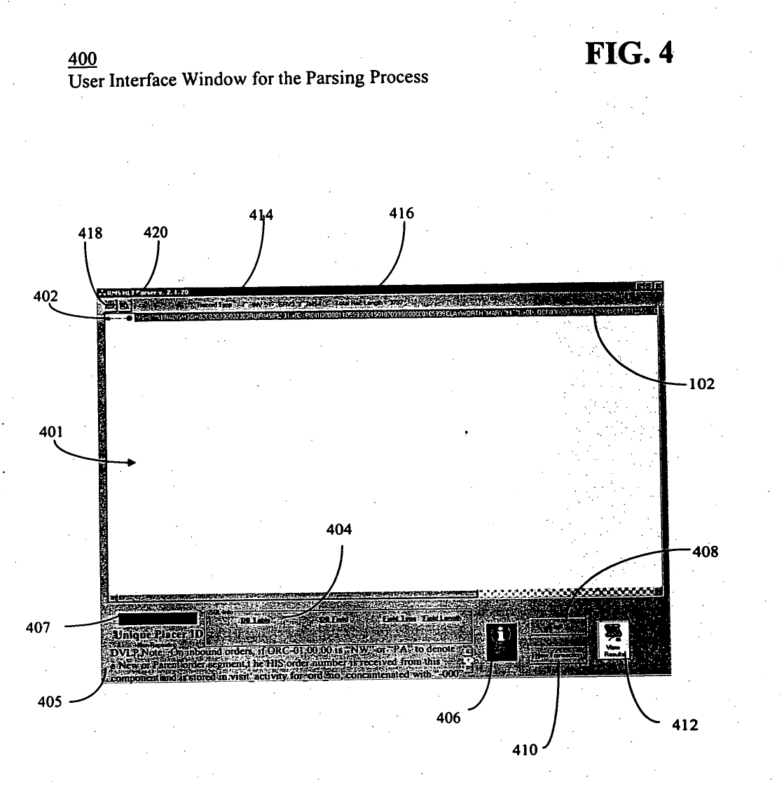

According to another aspect of the present invention, the system 100 advantageously provides standard HL7 information, in combination with associated ancillary information 112 (e.g., from a clinical application) from the repository 106. The clinical application may be a radiology management system (“RMS”), for example, used by a radiology department. Examples of ancillary information 112 provided to a user include information, as shown in FIGS. 4, 5, and 6 (e.g., shown as “SQL info”). The system 100 provides the combination of the standard HL7 information with the associated ancillary information 112 for the user via a friendly user interface device and layout. The system 100 benefits the user because the combined information is readily accessible from the single user interface, which reduces time, errors, lost information, system expense, etc. Hence, the system 100 provides HL7 compatible healthcare information and provides healthcare information that is specific and relevant to a particular healthcare department in a format that is user friendly. For example, fields in the HL7 information are given unique keys, such as for example, “PID 05.01.00,” which indicates PID segment, field 5, component 1, sub-component 0, respectively. The system 100 uses the unique key to make a query (e.g., a sequel (“SQL”) query) to the repository 106 to retrieve the associated ancillary information 112. The data processor 108 collates (i.e., processes or combines) the retrieved the ancillary information 126 with the information in the data field 124 to generate collated information, represented as image data 130 or an output 128. For the field label PID 5.1 example, the system 100 provides the standard HL7 field name and determines that the table name that holds this information in clinical application database is “pat_name,” and in “pat_name,” the field is called “pt_last.”In another example, if field label PID 6.0 is identified, the system 100 provides the standard HL7 name of “mother's maiden name” without any associated clinical application database information, since no associated information is available in the database.

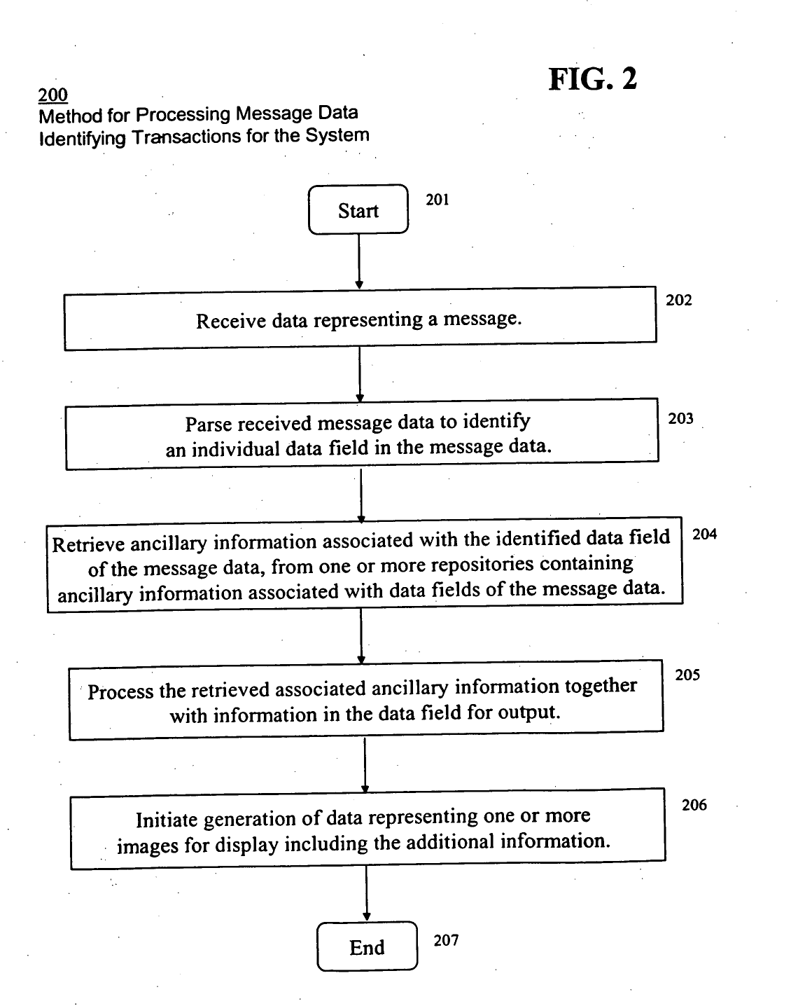

FIG. 2 illustrates a method 200 for processing message data 120 identifying transactions for the system 100, as shown in FIG. 1. Alternatively, the steps in the method 200 may be used with any system.

At step 201, the method 200 starts.

At step 202, the input processor 102 receives data representing a message 120 and generates received message data 122.

At step 203, the parser 104 parses the received message data 122 to identify information 124 in an individual data field in the received message data 122.

At step 204, the data processor 108 retrieves ancillary information 112, associated with the identified data field of the received message data 122, from the repository 106 containing the ancillary information 112 associated with data fields of the received message data 122.

At step 205, the data processor 108 processes the retrieved associated ancillary information 126 together with the information 124 in the data field for output 128.

At step 206, the display generator 116 initiates generation of data 134 representing one or more images (300, 400, 500, 600, 700, 800) for display including the additional information.

At step 207, the method 200 ends.

FIG. 3 illustrates a user interface window 300 for the input process 102 of the system 100 and method 200, as shown in FIGS. 1 and 2, respectively. When the system 100 (FIG. 1) runs the method 200 (FIG. 2) the user is presented with the window 300. The window 300 permits a user to process message data for HL7 transactions using the input processor 102 in the system 100 (FIG. 1) according to the step of receiving 202 in the method 200 (FIG. 2). The window 300 is otherwise called a “process transaction screen.” The window 300 includes a display area 302, a “Clear” box 304, a “Clear and Paste” box 306, an “Exit” box 308, a “Process Transaction” box 310, and a delimiter 312 (e.g., <×0D>).

The display area 302 represents the large open area in the window 300 and displays for the user message data 120 for the transaction. The user may delete the message data 120 displayed in the display area 302 by selecting (i.e., clicking on) the “Clear” box 304. The user may delete the message data 120 for the transaction displayed in the display area 302, and insert (i.e., paste) new or different message data 120 into the display area 302 by selecting the “Clear and Paste” box 306. The user may also insert message data 120 from sample transactions by selecting a right hand side mouse button (i.e., right clicking on) while the cursor is positioned over the “Process Transaction” box 310. The user may exit (i.e., close) the window 300 by selecting the “Exit” box 308. When the display area 302 displays the desired message data 120 for the transaction, the user causes the system 100 (FIG. 1) running the method 200 (FIG. 2) to continue by selecting the “Process Transaction” box 310.

The delimiters 312, otherwise called identifiers or field labels, separate (i.e., distinguish or identify) information fields at various levels of granularity (i.e., detail) in the message data 120 (FIG. 1). The levels of granularity mean that the third level is nested within the second level, and the second level is nested within the first level. There may be any number of first levels strung together and any number of levels of granularity in a transaction to comprise the message data 120 (FIG. 1).

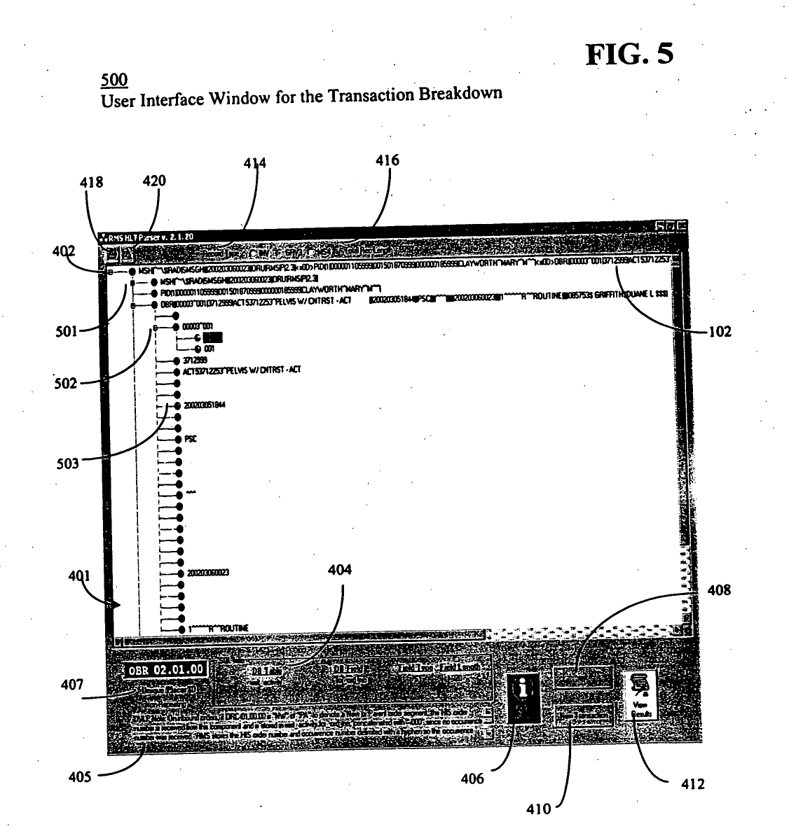

Various delimiters shown in the message data 120 displayed in the display area 302 include, as shown in closed quotation marks: at a first level “<×0D>”; at a second level “|”; and at a third level “\hat{0}”. The levels of delimiters correspond to the hierarchy of field labels from the segment (i.e., high) level to the sub-component (i.e., low) level, described above. Because the delimiters are strung together with the field information in FIG. 3, the delimiters and the field information are difficult for a user to manually parse. The system 100 overcomes this manual deficiency by automating the parsing process, as described in further detail with reference to FIGS. 4 and 5.

The system 100 distinguishes the delimiters from the information to decode the message data 120 (FIG. 1). The delimiters 312 may be of any length, type, character, symbol, number, letter, etc. Some individual elements in the delimiters 312 may be the same as an individual elements representing information, if the individual elements in the delimiters 312 are part of a string of symbols or characters in the delimiters 312 or other unique combination or mechanism that can be recognized and distinguished by the system 100 as different from the information identified by the delimiters. Typically, individual elements in a delimiter 312, having only one element, are different from individual elements representing information so that the system 100 does not confuse the delimiters and the information in the message data 120.

A simple example of message data 120 using the delimiters 312 at various levels, wherein letters A-G represent information in the data fields and shown in closed quotation marks is: “AAA|BBB|CCC\hat{0}DDD|<×0D>EEE|FFF\hat{0}GGG<×0D>.” In this example, the two first level delimiters “<×0D>” separate a first group of information and other delimiters “AAA|BBB|CCC\hat{0}DDD|” from a second group of information and other delimiters “EEE|FFF\hat{0}GGG”.

Next, in the simple example, the three second level delimiters “|” in the first group of information and other delimiters (i.e., “AAA|BBB|CCC\hat{0}DDD|”) separate a first set of information “AAA” from a second set of information “BBB” and from a third group of information and other delimiters “CCC\hat{0}DDD.” Likewise, the one second level delimiter “|” in the second group of information and other delimiters (“EEE|FFF\hat{0}GGG”) separates a first set of information “EEE” from a second group of information and other delimiters “FFF\hat{0}GGG.”

Next, in the simple example, one third level delimiter “\hat{0}” in the third group of information and other delimiters (i.e., “CCC\hat{0}DDD”) separate a first set of information “CCC” from a second set of information “DDD.” Likewise, the one third level delimiter “\hat{0}” in the second group of information and other delimiters (i.e., “FFF\hat{0}GGG”) separates a first set of information “FFF” from a second set of information “GGG.”

Therefore, this simple example shows how delimiters 312 may be used to identify information fields at various levels in the message data 120 (FIG. 1). Any number of levels of data fields may be represented in the message data 120 (FIG. 1). The message data 120 (FIG. 1) may also have two identical delimiters 312 next to each other representing no information in that particular data field at that particular level. FIGS. 4 and 5 illustrate a more detailed description of the how the system 100 (FIG. 1) parses the message data 120 (FIG. 1) using the method 200 (FIG. 2).

Next, FIGS. 4 and 5 are described together. FIGS. 4 and 5 illustrate a user interface window 400 and 500, respectively, for the parsing process of the system 100 and method 200, as shown in FIGS. 1 and 2, respectively. FIGS. 4 and 5 represent the same window except for the way the message data 120 (FIG. 1) is displayed in a display area 401.

After the user selects (i.e., clicks on) the “Process Transaction” box 310 (FIG. 3), the user is presented with the window 400. The window 400 permits a user to process message data for HL7 transactions using the parser 104 in the system 100 (FIG. 1) according to the step of parsing 203 in the method 200 (FIG. 2). The window 400 is otherwise called a “main parsing window” because it shows the message data 120 for the transaction that has been parsed (i.e., parsed and stored) or may be parsed (i.e., parsed in real time). The window 500 is otherwise called a “transaction breakdown window” because it shows the break down of the message data 120 for the transaction that has been parsed. The window 400 includes a display area 401, an image element 402, database information 404, a “Quick Stats” box 406, an “Exit” box 408, a “New Transaction” box 410, a “View Results” box 412, a “Record Type” indicator 414, “Total Record Length” data 416, a “Print” icon 418, and a “Lookup” icon 420.

The message data 120 (FIG. 1) displayed in display area 401 is the same message data 120 displayed in the display area 302 in FIG. 3. In the display area 401 in FIG. 4, the message data 120 (FIG. 1) is displayed in a single row, and does not show all of the message data 120 due to the limited width of the display area 401. Although not all of the message data 120 is shown in the width of the display area 401, a beneficial feature of the system 100 is that the various levels of the information fields are separated and displayed on one or more rows in the display area 401, as shown in FIG. 5.

The image element 402 is a known element that shows a “+” sign when the image element 402 is collapsed, as shown in FIG. 4, and shows a “−” sign when the image element 402 is expanded, as shown in FIG. 5. The user may expand and collapse the fields in the message data 120 (FIG. 1) in the display area 401 by selecting the image element 402. When the image element 402 is collapsed, as shown in FIG. 4, entire the message data 120 (FIG. 1) is shown in a single row, thereby obstructing part of the message data 120 shown in the display area 401. When the image element 402 is expanded, as shown in FIG. 5, one or more image elements 501, 502, and 503, as shown in FIG. 5, and corresponding portions of the message data 120 are shown corresponding to the various levels of the data fields shown in the display area 401. The system 100 displays each image element 501, 502, and 503 and corresponding portions of the message data 120 in a single row and indented immediately under the previous image element. Each image element 501 and 502 that includes additional levels of data fields in the message data 120 includes another image element so that that image elements may be opened or closed to display a further breakdown of the message data 120. Each image element 503 that does not include additional levels of data fields in the message data 120 does not include another image element because the message data 120 cannot be broken down any further.

The expanding and collapsing of the image elements to display various levels of information separated by various levels of delimiters 312 (FIG. 3) in the message data 120 is otherwise called “parsing” the message data 120, which correspond to the parser 104 in FIG. 1 and the step of parsing 203 in FIG. 2. Under the image elements, different colored dots highlight the various levels of the information. The various levels of information in the message data 120 are described using terms, such as for example, segments, data fields, components, and sub-components. The expanding of the image elements breaks down (i.e., separates or dissects) the transaction into portions of the message data 120 called “segments.” Further opening of the image elements breaks down the segments into portions of the message data 120 called “data fields.” Further opening of the image elements breaks down the data fields into portions of the message data 120 called “components.” Further opening of the image elements breaks down the components into portions of the message data 120 called “sub-components.”

The database information 404 displays details about the database storing the message data 120 (FIG. 1). The details are generally described, for example, as sequel information (i.e., “SQL Info”) to represent information in a sequel database. The details include, for example, a database table (“DB Table”) (e.g., “visit_activity), a database field (“DB Field”) (e.g., for_ord_no), a database field type (e.g., ST), and a database field length (e.g., 20). For example, when a user selects a segment, a data field, a component or sub-component, the system 100 displays the SQL information 404 available from the database 106).

The note section 405 permits a user, a system developer, or another party to insert a description related to the parsing process or other processes.

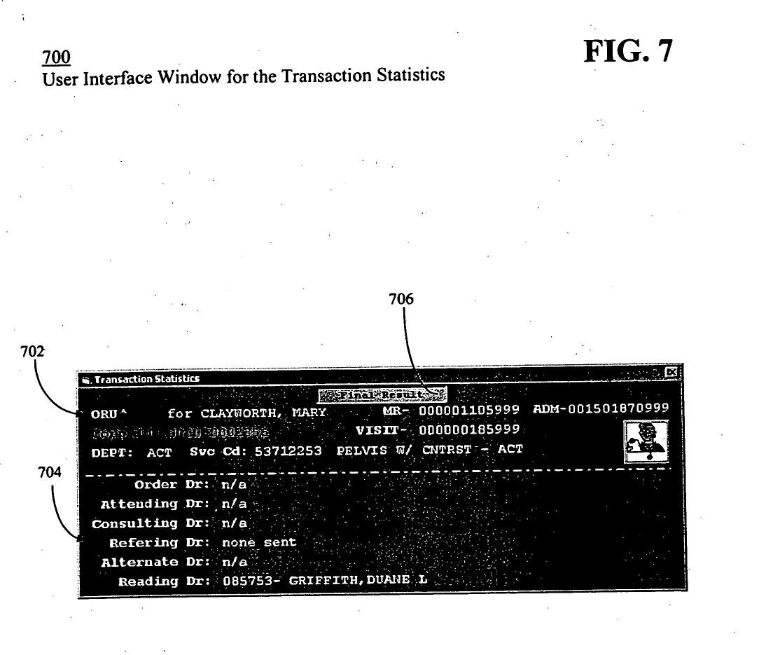

Selection of the “Quick Stats” box 406 permits a user to display statistics about the transaction. The statistics are displayed by opening another window 700, as shown in FIG. 7, by selecting (i.e., clicking on) the “Quick Stats” box 406, but may also be displayed in the same window 400, if desired. Further details of the window 700 are described with reference to FIG. 7.

The placement identifier (“ID”) 407 describes the location of the portion of the message data 120 for the transaction that is presently highlighted and broken down in the display area 401. An HL7 system describes the identifier 407 as the “unique placer ID.” The identifier 407 will be red, if a selected field is a required field. For example, from left to right the identifier 407, OBR 02.01.00, represents the observation request (“OBR”) segment, the second data field of the segment (i.e., “00003\hat{0}001”), the first component of the data field (i.e., “00003”), and no sub-components.

Selection of the “Exit” box 408 permits the user to exit (i.e., close) the windows 400 (FIG. 4) or 500 (FIG. 5).

Selection of the “New Transaction” box 410 permits the user to parse message data 120 (FIG. 1) for a new or different transaction.

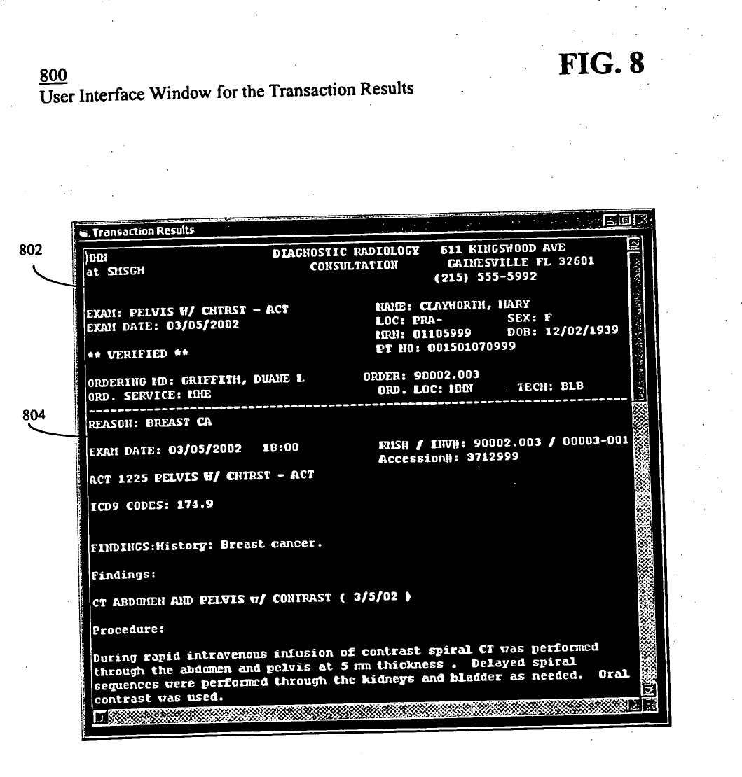

Selection of the “View Results” box 412 permits a user to display results about the transaction. The results are displayed by opening another window 800, as shown in FIG. 8, by selecting (i.e., clicking on) the “View Results” box 412, but may also be displayed in the same window 400, if desired. Further details of the window 800 are described with reference to FIG. 8.

Selection of the “Record Type” indicators 414 permit a user to select a type of record to be displayed. Types of records include, for example, Invision (“INV”), Generic Record Versions 3 (“GR3”), and Med-Series 4 (“MS4”). Selection of a record type causes the data processor 108 to retrieve the appropriate information from the repository 106 by sending a message (e.g., a SQL call) to the repository 106.

The “Total Record Length” data 416 shows the length of the record displayed (e.g., 3797). The record length may be displayed in any format, such as numbers, or units, such as bytes.

Selection of the “Print” icon 418 permits a user to print out a graphical view of the window 400\.

Selection of the “Lookup” icon 420 permits a user to display information for the selected record type that is stored in the repository 106. The system 100 displays all, but may display only part, of the information for the selected record type. The information is displayed by opening another window 600, as shown in FIG. 6, by selecting (i.e., clicking on) the “Lookup” icon 420, but may also be displayed in the same window 400, if desired. Further details of the window 600 are described with reference to FIG. 6.

FIG. 6 illustrates a user interface window 600 for the lookup function (FIGS. 4 and 5) of the system 100 and method 200, as shown in FIGS. 1 and 2, respectively. The system displays the window 600 when the user selects the “Lookup” icon 420, as shown in FIGS. 4 and 5. The window 600 includes a display area 601, database information area 602, and sorting selections 603. The display area 601 further includes three columns of information including a segment column 604, an information placement column 605, and a field name column 606.

The system 100 displays any information related to the message data 120 including that shown in the display area 601. When the system 100 opens the window 600, the system 100 initially displays the information for the record type currently being viewed in the display area 601 ascending alphabetically by the field name in column 606. The system 100 retrieves the information in the display area 601 and in the database information area 602 from the repository 106 (FIG. 1) using a known sequel (“SQL”) query. The information in the display area 601 includes segment information (e.g., MHS, PID, OBR, DGL) from the message data being viewed as shown in column 604. The information in the display area 601 also includes unique placer IDs, as described above for element 407 (FIGS. 4 and 5), as shown in column 605. The information in the display area 601 also includes field names 606 providing a description of the identified location of the information in the message data 120 (FIG. 1). The information across the three columns in a single row relates or corresponds to each other. For example, the highlighted information in the second row from the top includes segment “DGL,” corresponding to unique placer ID “03.00.00,” and corresponding to field name “Diagnosis Code.”

The sorting selections 603 permit a user to sort the information in the display area 601 by either field name (i.e., column 606) or by segment description (i.e., column 604). The system 100 sorts the information in the display area 601 according to the field names in column 606 when the user selects (i.e., clicks on) the “Name Sort” option. The system 100 sorts the information in the display area 601 according to the segment descriptions in column 604 when the user selects (i.e., clicks on) the “Segment Sort” option. The system 100 sorts the information in the display area 601 by either field name (i.e., column 606) or by segment description (i.e., column 604) in response to the user's selection by changing the SQL query of the repository 106. Typically, the field names in column 606 and the segment descriptions in column 604 are sorted in ascending alphabetical order. After the system 100 sorts the field names or segment descriptions, the user may manually search (i.e., scan) through the information in the display area 601 using the scroll bar on the right side of the window 600 to find the desired information. Alternatively or additionally, the window 600 may also include a search mechanism (not shown) to permit a user to automatically search for any type of desired information stored in the repository 106, including that information shown in the display area 601.

The database information area 602 displays any information in the repository 106 related to the message data 120 (FIG. 1) including that shown in FIG. 6. The system 100 displays information related to the message data in the database information area 602 that correspond to the highlighted row of information in the display area 601. The information in the database information area 602 is also retrieved from the repository 106 using a SQL query. Therefore, the database information area 602 provides further details about the information highlighted in the display area 601. The database information area 602 shown in FIG. 6 is the same information as shown in the database information area 404 shown in FIG. 4.

FIG. 7 illustrates a user interface window 700 displaying the transaction statistics of the system 100 and method 200, as shown in FIGS. 1 and 2, respectively. The system 700 displays the window 700 when the user selects (i.e., clicks on) the “Quick Stats” icon 420, as shown in FIGS. 4 and 5. The window 700 includes a first display area 702 and a second display area 704.

The system 100 displays any information communicated in the message data 120 (FIG. 1) for the transaction including that shown in the window 700. Most transactions have pertinent data that is examined for display in the window 700, including for example, transaction type, transaction subtype, medical record number, admission number, corporate (i.e., corp) id (if present), and visit number. The system 100 displays certain data fields and excludes other data fields depending on the type of the transaction. Certain transactions provide additional information, described for example as follows.

An admission record (identified as “ADT”), for example, for a change medical record transaction (identified as “A18”), includes additional information about a patient's medical records. When the system 100 processes this type of transaction, the system 100 provides a description in sentence form explaining instructions. The system 100 generates the information in the window 700 for this type of record by parsing (i.e., pulling or retrieving) out the text from predetermined fields (e.g., Patient Identification (“PID”) and Merge Patient Information (“MRG”) segments) and displays it in predetermined portions of the window 700. For example, the description might read “Move visit 12345 under Admit 45678 from MR 2828289 to MR 128218912.”

A result record (identified as “ORU”) includes additional information about a patient's test results related to a transaction. When the system 100 processes this type of transaction, the system 100 inserts a label 706 at the top of the window 700 in the first display area 701 indicating the result status, such as for example, “Preliminary,” “Final,” or “Addendum.”

An order record (identified as “ORM”) includes additional information about a patient's orders related to a transaction. When the system 100 processes this type of transaction, the system 100 inserts extra lines to show the department and the procedure that was ordered, as shown in the second display area 702.

FIG. 8 illustrates a user interface window for the transaction results of the system and method, as shown in FIGS. 1 and 2, respectively. The system 100 displays the window 800 when the user selects (i.e., clicks on) the “View Results” icon 412, as shown in FIGS. 4 and 5. The window 800 includes a first display area 802 and a second display area 804.

The system 100 provides any results information communicated in the message data (FIG. 1) for a transaction including that shown in the window 800. A results transaction (“ORU”) in an HL7 communication protocol identifies results information in the message data 120 (FIG. 1) using observation/result (“OBX”) segments. The OBX segments include delimiters (e.g., “×0D”) that identify characters representing the results information. For example, field five of an OBX segment includes results information that is communicated between information systems to denote the findings of a completed order.

The system 100 enables and disables the “View Results” icon 412 when the message data 120 for the transaction includes and does not include, respectively, the results information. The system 100 generates the results information for display in the window 800 either before or after the user selects the “View Results” icon 412, and displays the results information after the user selects the “View Results” icon 412.

The system 100 generates the results information for display in the window 800 by parsing out the text from predetermined fields (e.g., in an OBX segment), and displaying the text in predetermined portions of the window 800.

The system 100 performs this function using executable code in the system 100 and does not depend on an outside source. Generally, the executable code identifies the results information identified by delimiters (e.g. an OBX segment), and displays the results information in a predetermined display location in the window 800. In particular, the executable code combines the results information from the OBX segments into a single string of information. The executable code provides feed lines in the string of information by replacing (i.e., converting) the delimiters (e.g., “×0A”) in the string with other characters or symbols (e.g., the tilda (˜)) to simplify the process for displaying the results information. The executable code processes the new string of information having the feed lines to display the results information in predetermined portions of the window 800 for a user to view.

The system 100 displays the results information in a format as if it was being printed so that it can be easily read and/or printed by a user. The window 800 may have any format, and displays general results information in the first display area 802 and more detailed results information in the second display area 802.

Any system that uses a record layout, such as a HL7 compatible system, may use the system 100 and method 200, as described herein. Advantages of the system 100 and method 200 include the following, for example:
color-coded break out of tree view for easy viewing (FIGS. 4 and 5);
ability to change record type from GRV3, INV, or MS4 (FIGS. 4 and 5);
determine total record length (FIGS. 4, 5, and 6);
print an expanded view of the HL7 transaction (FIG. 5);
view DB information about selected fields if available (FIGS. 4, 5, and 6);
determine if a selected field is a required one (FIG. 4);
view quick snapshot of important transaction information (FIG. 7);
view standard doctors related to transactions (FIGS. 7 and 8);
scan standard HL7 specifications alphabetically by name or segment (FIG. 6);
choose standard HL7 transactions to view fields (FIG. 6); and
view result text that is included in result transactions (FIG. 8);

The system 100 facilitates reading, identifying, and interpreting HL7 transactions that are used to transmit patient data from one hospital system to another, for example. The system 100 advantageously enables a transaction to be broken down into its segments, fields, components and sub-components, and displays a description of a selected data element. For example, assume a user desires to view an admissions record from another system and to see what was in an OBR segment, in the second field, and in the first component. The system 100 advantageously assist the user to view the desired information by parsing the transaction, which separates the transaction, finds the segment, breaks it down, finds the second field, selects it, finds the first component, selects it, presents what is contained in the selected fields, as well as corresponding database information about the fields.

While the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A message data processing system suitable for processing messages identifying transactions, comprising:
an input processor for receiving data representing a message;
a parser for parsing received message data to identify an individual data field in said message data;
at least one repository containing ancillary information associated with data fields of said message data; and
a data processor for retrieving ancillary information, associated with said identified data field of said message data, from said at least one repository, and for processing said retrieved associated ancillary information together with information in said data field for output.

2. A system according to claim 1, wherein
said message data concerns a healthcare activity concerning a patient, and
said ancillary information associated with said identified data field of said message data comprises information derived from a clinical information database associated with said healthcare activity.

3. A system according to claim 2, wherein
said healthcare activity comprises at least one of, (a) patient admission, discharge or transfer from a hospital, (b) patient allergies, (c) radiology, (d) laboratory tests, (e) medication, (f) diet, and (g) therapy.

4. A system according to claim 1, wherein
said message data concerns a healthcare activity concerning a patient, and
said data processor processes said information in said data field for output together with additional information indicating at least one of, (a) activity type, (b) activity sub-type, (c) medical record number associated with said patient, (d) admission number associated with said patient, (e) a corporation identifier, (f) a visit identifier, (g) a patient identifier and (h) a physician associated said healthcare activity.

5. A system according to claim 4, including
a display generator for initiating generation of data representing at least one image for display including said additional information.

6. A system according to claim 1, wherein
said message data concerns a healthcare activity concerning a patient, and
said message data is in a Health Level 7 (HL7) compatible data format.

7. A system according to claim 6, wherein
said message data concerns a healthcare activity concerning a patient, and including
a display generator for initiating generation of data representing at least one image for display, said at least one image including information associated with said identified data field and indicating said identified data field is a particular HL7 data field.

8. A system according to claim 1, wherein
said message data concerns a healthcare activity concerning a patient, and including
a display generator for initiating generation of data representing at least one image for display, said at least one image including information associated with said identified data field and indicating at least one of, (a) activity type, (b) activity sub-type, (c) medical record number associated with said patient, (d) admission number associated with said patient, (e) a corporation identifier, (f) a visit identifier, (g) a patient identifier and (h) a physician associated with said healthcare activity,
in response to user activation of a displayed button.

9. A system according to claim 1, wherein
said data processor processes said retrieved associated ancillary information together with information in said data field for at least one of, (a) display on a reproduction device, (b) communication to a remote system and (c) print output.

10. A system according to claim 1, wherein
said message data concerns a healthcare activity concerning a patient, and including
a transaction comprises an activity associated with delivering healthcare to a patient.

11. A method for processing message data identifying transactions, comprising the activities of:
receiving data representing a message;
parsing received message data to identify an individual data field in said message data;
retrieving ancillary information associated with said identified data field of said message data, from at least one repository containing ancillary information associated with data fields of said message data; and
processing said retrieved associated ancillary information together with information in said data field for output.

12. A method according to claim 11 further comprising the activity of:
initiating generation of data representing one or more images for display including the associated ancillary information together with information in the data field.

13. A system comprising:
a display generator for initiating generation of data representing at least one image for display;
an input processor for receiving message data identifying a transaction to generate received message data, wherein the display generator initiates generation of data, including the received message data, representing a first image for display;
a parser for parsing the received message data to identify information in at least one field in the message data, wherein the display generator initiates generation of data, including the identified information, representing a second image for display;
a data processor for retrieving ancillary information, associated with the identified field in the message data, from at least one repository, and for processing the retrieved associated ancillary information together with information in the field in the message data for output, wherein the display generator initiates generation of data, including the retrieved associated ancillary information together with identified information, representing a third image for display.

14. A user interface for a system comprising:
a display generator for initiating generation of data representing at least one image for display of:
received message data for a transaction in a first image in response to the system receiving message data for a transaction,
identified information in a second image in response to the system parsing the received message data, and
retrieved associated ancillary information together with information in the identified field in a third image in response to the system processing the retrieved associated ancillary information together with information in the identified field.

15. A user interface according to claim 14 further comprising:
a data input device for receiving commands instructing the system to:
receive the message data identifying the transaction to generate the received message data,
parse the received message data to identify the information in at least one field in the message data,
retrieve the ancillary information, associated with the identified field in the message data, from at least one repository, and
process the retrieved associated ancillary information together with information in the identified field.

16. A user interface according to claim 14 further comprising:
a display for displaying the first, second, and third images.

17. A system comprising:
at least one repository for storing ancillary information; and
a data processor for retrieving from the repository ancillary information, associated with an identified field in received message data for a transaction, and for processing the retrieved associated ancillary information together with information in the identified field.

18. A method for automatically processing message data for a transaction, comprising the steps of:
receiving message data for a transaction;
locating predetermined field identifiers in the message data to identify fields of information in the message data in response to receiving the message data;
separating the fields of information in the message data in response to locating the predetermined field identifiers; and
initiating generation of data representing one or more images, representing the separated fields of information, for display in format that is friendly to a user of the system (100).

19. A method according to claim 18 further comprising the step of:
displaying images, representing the separated fields of information, in response to requests from the user.

20. A method according to claim 18 further comprising the steps of:
retrieving ancillary information, associated with the identified field in the message data, from at least one repository;
processing the retrieved associated ancillary information together with information in the identified field; and
initiating generation of data representing one or more images, representing the retrieved associated ancillary information together with information in the identified field, for display in format that is friendly to a user of the system (100).
